(19) United States
(12) Patent Application Publication
(10) Pub. No.: US 2023/0412608 A1
(43) Pub. Date: Dec. 21, 2023

(54) ENTITY ACCESS FOR AN APPLICATION

(71) Applicant: Lenovo (Singapore) Pte. Ltd., New Tech Park (SG)

(72) Inventors: Ishan Vaishnavi, Woodridge, IL (US); Emmanouil Pateromichelakis, Viersen (DE)

(21) Appl. No.: 18/250,888

(22) PCT Filed: Oct. 27, 2020
(86) PCT No.: PCT/EP2020/080148

§ 371 Date: Apr. 27, 2023

(51) Int. Cl. H04L 9/40

(52) U.S. Cl. CPC H04L 63/102; H04L 63/101

(57) ABSTRACT

Apparatuses, methods, and systems are disclosed for entity access for an application. One method includes receiving, by a first entity, an application registry request for at least one application. The method includes determining whether the at least one application is enabled to access at least one management entity or at least one managed entity.

### FIELD

The subject matter disclosed herein relates generally to wireless communications and more particularly relates to entity access for an application.

### BACKGROUND

The following abbreviations are herewith defined, at least some of which are referred to within the following description: Third Generation Partnership Project (“3GPP”), 5^{th} Generation (“5G”), 5G System (“5GS”), 5G QoS Indicator (“5QI”), Authentication, Authorization, and Accounting (“AAA”), Positive-Acknowledgment (“ACK”), Application Function (“AF”), Automated Guided Vehicles (“AGV”), Artificial Intelligence (“AI”), Authentication and Key Agreement (“AKA”), Aggregation Level (“AL”), Access and Mobility Management Function (“AMF”), Angle of Arrival (“AoA”), Angle of Departure (“AoD”), Access Point (“AP”), Application Programmable Interface (“API”), Augmented Reality (“AR”), Access Stratum (“AS”), Application Service Provider (“ASP”), Autonomous Uplink (“AUL”), Authentication Server Function (“AUSF”), Authentication Token (“AUTN”), Background Data (“BD”), Background Data Transfer (“BDT”), Beam Failure Detection (“BFD”), Beam Failure Recovery (“BFR”), Binary Phase Shift Keying (“BPSK”), Base Station (“BS”), Buffer Status Report (“BSR”), Bandwidth (“BW”), Bandwidth Part (“BWP”), Control to Control (“C2C”), Cell RNTI (“C-RNTI”), Carrier Aggregation (“CA”), Channel Access Priority Class (“CAPC”), Common API Framework (“CAPIF”), Channel Busy Ratio (“CBR”), Contention-Based Random Access (“CBRA”), Clear Channel Assessment (“CCA”), Common Control Channel (“CCCH”), Control Channel Element (“CCE”), Cyclic Delay Diversity (“CDD”), Code Division Multiple Access (“CDMA”), Control Element (“CE”), Contention-Free Random Access (“CFRA”), Configured Grant (“CG”), Closed-Loop (“CL”), Core Network (“CN”), Coordinated Multipoint (“CoMP”), Category of Requirements (“CoR”), Channel Occupancy Time (“COT”), Cyclic Prefix (“CP”), Channel Quality Indicator (“CQI”), Cyclical Redundancy Check (“CRC”), Communication Service (“CS”), Channel State Information (“CSI”), Channel State Information-Reference Signal (“CSI-RS”), Common Search Space (“CSS”), Control Resource Set (“CORESET”), Discrete Fourier Transform Spread (“DFTS”), Dual Connectivity (“DC”), Downlink Control Information (“DCI”), Downlink Feedback Information (“DFI”), Dynamic Grant (“DG”), Downlink (“DL”), Demodulation Reference Signal (“DMRS”), Data Network (“DN”), Data Network Name (“DNN”), Data Radio Bearer (“DRB”), Discontinuous Reception (“DRX”), Dedicated Short-Range Communications (“DSRC”), Downlink Pilot Time Slot (“DwPTS”), Enhanced Clear Channel Assessment (“eCCA”), Enhanced Mobile Broadband (“eMBB”), Evolved Node B (“eNB”), Enhanced V2X (“eV2X”), Extensible Authentication Protocol (“EAP”), Edge Configuration Server (“ECS”), Edge Enabler Client (“EEC”), Edge Enabler Server (“EES”), Enhanced ICIC (“eICIC”), Effective Isotropic Radiated Power (“EIRP”), Evolved Packet System (“EPS”), European Telecommunications Standards Institute (“ETSI”), Frame Based Equipment (“FBE”), Frequency Division Duplex (“FDD”), Frequency Division Multiplexing (“FDM”), Frequency Division Multiple Access (“FDMA”), Frequency Division Orthogonal Cover Code (“FD-OCC”), Factory of the Future (“FF”), Frequency Range 1—sub 6 GHz frequency bands and/or 410 MHz to 7125 MHz (“FR1”), Frequency Range 2-24.25 GHz to 52.6 GHz (“FR2”), Universal Geographical Area Description (“GAD”), Guaranteed Bit Rate (“GBR”), Guaranteed Flow Bit Rate (“GFBR”), Group Leader (“GL”), 5G Node B or Next Generation Node B (“gNB”), Global Navigation Satellite System (“GNSS”), General Packet Radio Services (“GPRS”), Guard Period (“GP”), Global Positioning System (“GPS”), Generic Public Subscription Identifier (“GPSI”), Global System for Mobile Communications (“GSM”), Generic Network Slice Template (“GST”), Globally Unique Temporary UE Identifier (“GUTI”), Home AMF (“hAMF”), Hybrid Automatic Repeat Request (“HARQ”), Home Location Register (“HLR”), Handover (“HO”), Home PLMN (“HPLMN”), Home Subscriber Server (“HSS”), Hash Expected Response (“HXRES”), Inter-cell Interference Coordination (“ICIC”), Identity or Identifier (“ID”), Information Element (“IE”), Industrial Internet of Things (“IIoT”), International Mobile Equipment Identity (“IMEI”), International Mobile Subscriber Identity (“IMSI”), International Mobile Telecommunications (“IMT”), Information Object Class (“IoC”), Internet-of-Things (“IoT”), Intelligent Transportation Systems (“ITS”), Key Performance Indicator (“KPI”), Layer 1 (“L1”), Layer 2 (“L2”), Layer 3 (“L3”), Licensed Assisted Access (“LAA”), Local Area Data Network (“LADN”), Local Area Network (“LAN”), Load Based Equipment (“LBE”), Listen-Before-Talk (“LBT”), Logical Channel (“LCH”), Logical Channel Group (“LCG”), Logical Channel Prioritization (“LCP”), Log-Likelihood Ratio (“LLR”), Level of Automation (“LoA”), Line of Sight (“LOS”), Long Term Evolution (“LTE”), LTE Vehicle (“LTE-V”), Multiple Access (“MA”), Medium Access Control (“MAC”), Multimedia Broadcast Multicast Services (“MBMS”), Maximum Bit Rate (“MBR”), Minimum Communication Range (“MCR”), Modulation Coding Scheme (“MCS”), Management Domain (“MD”), Managed Element (“ME”), Mobile Edge Computing (“MEC”), Master Information Block (“MIB”), Massive IoT (“mIoT”), Multiple Input Multiple Output (“MIMO”), Machine Learning (“ML”), Mobility Management (“MM”), Mobility Management Entity (“MME”), Master Node (“MN”), Management Service (“MnS”), Mobile Network Operator (“MNO”), Mobile Originated (“MO”), Managed Object Instance (“MOI”), Mean Opinion Score (“MOS”), massive MTC (“mMTC”), Maximum Power Reduction (“MPR”), Multi-Radio Dual Connectivity (“MR-DC”), Machine Type Communication (“MTC”), Multiple Transmission and Reception Point (“M-TRP”), Multi User Shared Access (“MUSA”), Non Access Stratum (“NAS”), Narrowband (“NB”), Negative-Acknowledgment (“NACK”) or (“NAK”), New Data Indicator (“NDI”), Network Entity (“NE”), Network Exposure Function (“NEF”), Network Exposure Function/Service Capability Exposure Function (“NEF/SCEF”), NEtwork Slice Type (“NEST”), Network Function (“NF”), Non-LOS (“NLOS”), Next Generation (“NG”), NG 5G S-TMSI (“NG-5G-S-TMSI”), Neural Networks (“NN”), Non-Orthogonal Multiple Access (“NOMA”), Non Public Network (“NPN”), New Radio (“NR”), NR Unlicensed (“NR-U”), Network Repository Function (“NRF”), Network Slice as a Service (NsaaS), Network Scheduled Mode (“NS Mode”) (e.g., network scheduled mode of V2X communication resource allocation—Mode-1 in NR V2X and Mode-3 in LTE V2X), Network Slice Instance (“NSI”), Network Slice Selection Assistance Information (“NSSAI”), Network Slice Selection Function (“NSSF”), Network Slice Subnet Instance (“NSSI”), Network Slice Selection Policy (“NSSP”), Operation, Administration, and Maintenance System or Operation and Maintenance Center (“OAM”), Original Equipment Manufacturer (“OEM”), Orthogonal Frequency Division Multiplexing (“OFDM”), Orthogonal Frequency Division Multiple Access (“OFDMA”), Open-Loop (“OL”), Operator Defined Open and Intelligent Radio Access Networks (“O-RAN”), Other System Information (“OSI”), Over-the-top (“OTT”), Power Angular Spectrum (“PAS”), Physical Broadcast Channel (“PBCH”), Power Control (“PC”), UE to UE interface (“PC5”), Principal Component Analysis (“PCA”), Policy and Charging Control (“PCC”), Primary Cell (“PCell”), Policy and Charging Rules Function (“PCRF”), Policy Control Function (“PCF”), Physical Cell Identity (“PCI”), Physical Downlink Control Channel (“PDCCH”), Packet Data Convergence Protocol (“PDCP”), Packet Data Network Gateway (“PGW”), Physical Downlink Shared Channel (“PDSCH”), Pattern Division Multiple Access (“PDMA”), Packet Data Unit (“PDU”), Physical Hybrid ARQ Indicator Channel (“PHICH”), Power Headroom (“PH”), Power Headroom Report (“PHR”), Physical Layer (“PHY”), Public Land Mobile Network (“PLMN”), Precoding Matrix Index (“PMI”), Physical Network Function (“PNF”), Prose Per Packet Priority (“PPPP”), Prose Per Packet Reliability (“PPPR”), PC5 5QI (“PQIs”), Predictive QoS (“P-QoS”), Physical Random Access Channel (“PRACH”), Physical Resource Block (“PRB”), Proximity Services (“ProSe”), Positioning Reference Signal (“PRS”), Physical Sidelink Control Channel (“PSCCH”), Primary Secondary Cell (“PSCell”), Physical Sidelink Feedback Control Channel (“PSFCH”), Physical Uplink Control Channel (“PUCCH”), Physical Uplink Shared Channel (“PUSCH”), QoS Class Identifier (“QCI”), Quasi Co-Located (“QCL”), QoS Flow Indicator (“QFI”), Quality of Experience (“QoE”), Quality of Service (“QoS”), Quadrature Phase Shift Keying (“QPSK”), Registration Area (“RA”), RA RNTI (“RA-RNTI”), Radio Access Network (“RAN”), Random (“RAND”), Radio Access Technology (“RAT”), Serving RAT (“RAT-I”) (serving with respect to Uu), Other RAT (“RAT-2”) (non-serving with respect to Uu), Random Access Procedure (“RACH”), Random Access Preamble Identifier (“RAPID”), Random Access Response (“RAR”), Resource Block Assignment (“RBA”), Resource Element Group (“REG”), Representational State Transfer (“REST”), Rank Indicator (“RI”), RAN Intelligent Controller (“RIC”), Radio Link Control (“RLC”), RLC Acknowledged Mode (“RLC-AM”), RLC Unacknowledged Mode/Transparent Mode (“RLC-UM/TM”), Radio Link Failure (“RLF”), Radio Link Monitoring (“RLM”), Radio Network Information (“RNI”), RNI Service (“RNIS”), Radio Network Temporary Identifier (“RNTI”), Reference Signal (“RS”), Recursive Model (“RM”), Remaining Minimum System Information (“RMSI”), Radio Resource Control (“RRC”), Radio Resource Management (“RRM”), Resource Spread Multiple Access (“RSMA”), Reference Signal Received Power (“RSRP”), Received Signal Strength Indicator (“RSSI”), Real Time (“RT”), Round Trip Time (“RTT”), Receive (“RX”), Service Capability Exposure Function (“SCEF”), Sparse Code Multiple Access (“SCMA”), Service Provider (“SP”), Scheduling Request (“SR”), Sounding Reference Signal (“SRS”), Single Carrier Frequency Division Multiple Access (“SC-FDMA”), Secondary Cell (“SCell”), Secondary Cell Group (“SCG”), Shared Channel (“SCH”), Sidelink Control Information (“SCI”), Sub-carrier Spacing (“SCS”), Space Division Multiplexing (“SDM”), Service Data Unit (“SDU”), Security Anchor Function (“SEAF”), Service Enabler Architecture Layer (“SEAL”), Sidelink Feedback Content Information (“SFCI”), Serving Gateway (“SGW”), System Information Block (“SIB”), SystemInformationBlockType1 (“SIB1”), SystemInformationBlockType2 (“SIB2”), Subscriber Identity/Identification Module (“SIM”), Signal-to-Interference-Plus-Noise Ratio (“SINR”), Sidelink (“SL”), Service Level Agreement (“SLA”), Sidelink Synchronization Signals (“SLSS”), Session Management (“SM”), Session Management Function (“SMF”), Secondary Node (“SN”), Special Cell (“SpCell”), Single Network Slice Selection Assistance Information (“S-NSSAI”), Semi-Persistent Scheduling (“SPS”), Scheduling Request (“SR”), Signaling Radio Bearer (“SRB”), Shortened TMSI (“S-TMSI”), Shortened TTI (“sTTI”), Synchronization Signal (“SS”), Survival Time (“ST”), Sidelink CSI RS (“S-CSI RS”), Sidelink PRS (“S-PRS”), Sidelink SSB (“S-SSB”), Synchronization Signal Block (“SSB”), Subscription Concealed Identifier (“SUCI”), Scheduling User Equipment (“SUE”), Supplementary Uplink (“SUL”), Subscriber Permanent Identifier (“SUPI”), Support Vector Machine (“SVM”), Tracking Area (“TA”), TA Identifier (“TAI”), TA Update (“TAU”), Timing Alignment Timer (“TAT”), Transport Block (“TB”), Transport Block Size (“TBS”), Transmission Configuration Indicator (“TCI”), Time-Division Duplex (“TDD”), Time Division Multiplex (“TDM”), Time Division Orthogonal Cover Code (“TD-OCC”), Time Domain Resource Allocation (“TDRA”), Temporary Mobile Subscriber Identity (“TMSI”), Time of Flight (“ToF”), Transmission Power Control (“TPC”), Transmission Reception Point (“TRP”), Time Sensitive Communication (“TSC”), Time Sensitive Assistance Information (“TSCAI”), Time Sensitive Networking (“TSN”), Transmission Time Interval (“TTI”), Transmit (“TX”), Unmanned Aircraft System (“UAS”), Uplink Control Information (“UCI”), Unified Data Management Function (“UDM”), Unified Data Repository (“UDR”), User Entity/Equipment (Mobile Terminal) (“UE”) (e.g., a V2X UE), UE Autonomous Mode (UE autonomous selection of V2X communication resource—e.g., Mode-2 in NR V2X and Mode-4 in LTE V2X. UE autonomous selection may or may not be based on a resource sensing operation), Uplink (“UL”), UL SCH (“UL-SCH”), Universal Mobile Telecommunications System (“UMTS”), User Plane (“UP”), UP Function (“UPF”), Uplink Pilot Time Slot (“UpPTS”), Uniform Resource Locator (“URL”), Ultra-reliability and Low-latency Communications (“URLLC”), UE Route Selection Policy (“URSP”), Vehicle-to-Vehicle (“V2V”), Vehicle-to-Everything (“V2X”), V2X Control Function (“V2XCF”), V2X UE (e.g., a UE capable of vehicular communication using 3GPP protocols), V2X Application Enabler (“VAE”), Visiting AMF (“vAMF”), Virtual Network Function (“VNF”), Visiting NSSF (“vNSSF”), Visiting PLMN (“VPLMN”), Virtual Reality (“VR”), Wide Area Network (“WAN”), and Worldwide Interoperability for Microwave Access (“WiMAX”).

In certain wireless communications networks, management entities or managed entities may be used.

### BRIEF SUMMARY

Methods for entity access for an application are disclosed. Apparatuses and systems also perform the functions of the methods. One embodiment of a method includes receiving, by a first entity, an application registry request for at least one application. In some embodiments, the method includes determining whether the at least one application is enabled to access at least one management entity or at least one managed entity.

One apparatus for entity access for an application includes a receiver that receives an application registry request for at least one application. In various embodiments, the apparatus includes a processor that determines at least one management entity or at least one managed entity of the telecom management system based on the application registry request, wherein the at least one application is enabled to access the at least one management entity or the at least one managed entity.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for entity access for an application;

FIG. 2 is a schematic block diagram illustrating one embodiment of an apparatus that may be used for entity access for an application;

FIG. 3 is a schematic block diagram illustrating one embodiment of an apparatus that may be used for entity access for an application;

FIG. 4 is a communications diagram illustrating one embodiment of communications for application registration with a telecom management system;

FIG. 5 is a communications diagram illustrating another embodiment of communications for application registration with a telecom management system (e.g., 3GPP system);

FIG. 6 is a communications diagram illustrating a further embodiment of communications for application registration with a telecom management system (e.g., O-RAN system); and

FIG. 7 is a flow chart diagram illustrating one embodiment of a method for entity access for an application.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

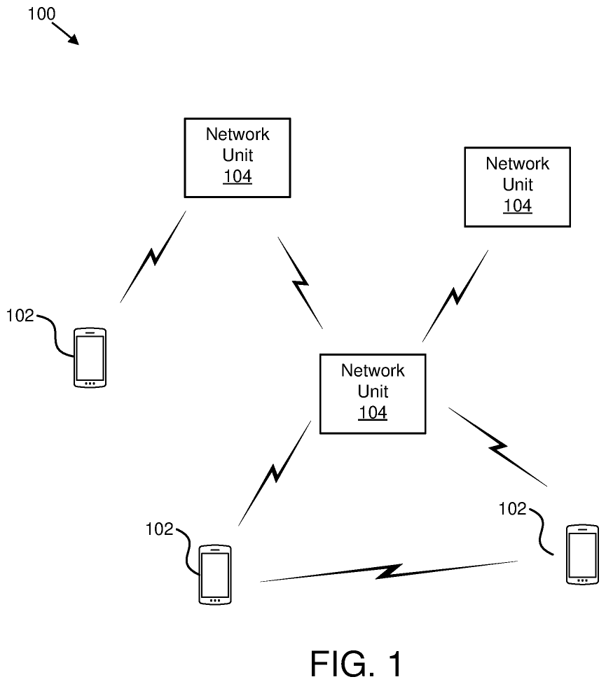

FIG. 1 depicts an embodiment of a wireless communication system 100 for entity access for an application. In one embodiment, the wireless communication system 100 includes remote units 102, and network units 104. Even though a specific number of remote units 102, and network units 104 are depicted in FIG. 1, one of skill in the art will recognize that any number of remote units 102, and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a Node-B, an eNB, a gNB, a Home Node-B, a relay node, a device, a core network, an aerial server, a radio access node, an AP, NR, a network entity, an AMF, a UDM, a UDR, a UDM/UDR, a PCF, a RAN, an NSSF, an OAM, an SMF, a UPF, an application function, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in 3GPP, wherein the network unit 104 transmits using an OFDM modulation scheme on the DL and the remote units 102 transmit on the UL using a SC-FDMA scheme or an OFDM scheme. More generally, however, the wireless communication system 100 may implement some other open or proprietary communication protocol, for example, WiMAX, IEEE 802.11 variants, GSM, GPRS, UMTS, LTE variants, CDMA2000, Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a network unit 104 may receive, by a first entity, an application registry request for at least one application. In some embodiments, the network unit 104 may determine whether the at least one application is enabled to access at least one management entity or at least one managed entity. Accordingly, the network unit 104 may be used for entity access for an application. As used herein, a management entity may refer to any entity that manages another entity or device (e.g., a management entity may be a management domain, vendor device, vendor solution 5GS operator domain, 3GPP core, 3GPP RAN, cloud domain, datacenter, transport network, operator administrative domain, country domain, LCM, FCAPS management, API management, and so forth). Moreover, as used herein a managed entity may refer to any entity that is managed by another entity or device (e.g., a managed entity may be: API, CS, NSI, NSSI, network functions or other resources in telecom networks such as virtualized network function and/or physical entities such as PNFs).

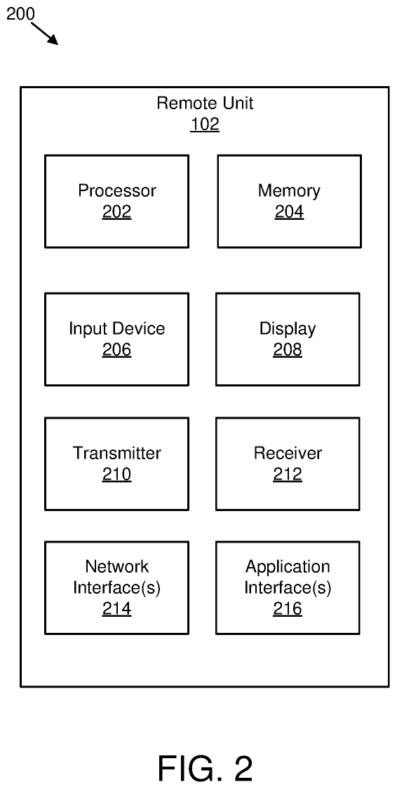

FIG. 2 depicts one embodiment of an apparatus 200 that may be used for entity access for an application. The apparatus 200 includes one embodiment of the remote unit 102. Furthermore, the remote unit 102 may include a processor 202, a memory 204, an input device 206, a display 208, a transmitter 210, a receiver 212, one or more network interfaces 214, and one or more application interfaces 216. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, an LCD display, an LED display, an OLED display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

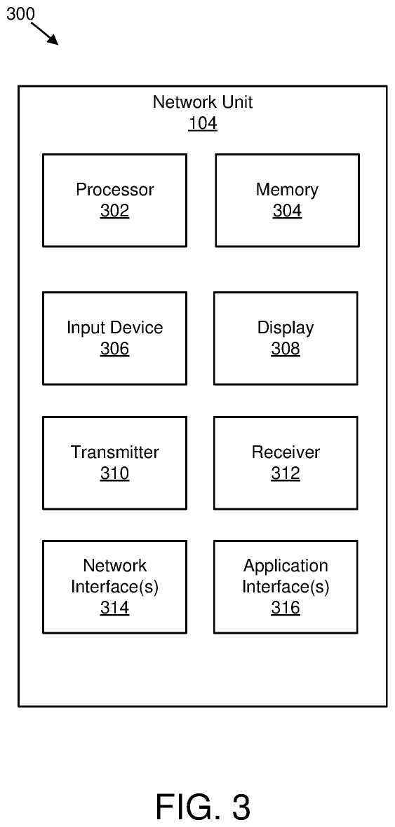

FIG. 3 depicts one embodiment of an apparatus 300 that may be used for entity access for an application. The apparatus 300 includes one embodiment of the network unit 104. Furthermore, the network unit 104 may include a processor 302, a memory 304, an input device 306, a display 308, a transmitter 310, a receiver 312, one or more network interfaces 314, and one or more application interfaces 316. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, the receiver 312 may receive an application registry request for at least one application. In various embodiments, the processor 302 may determine at least one management entity or at least one managed entity of the telecom management system based on the application registry request, wherein the at least one application is enabled to access the at least one management entity or the at least one managed entity.

In some embodiments, a third party application, such as a V2X application, may use telecom management system services to manage telecom networks. In such embodiments, the telecom management system may need to be made aware of these applications. Moreover, in such embodiments, a telecommunication management system may refer to management systems according to a specification of telecom standard bodies such as 3GPP or ETSI.

In certain embodiments, network slicing is a key feature (e.g., 5G). In such embodiments, network slicing may introduce logical end-to-end sub-networks corresponding to different verticals. In some embodiments, network slicing may enable the deployment of multiple logical networks known as network slice instances offering 3rd parties and verticals customized communication services on the top of a shared infrastructure. In various embodiments, based on a physical network that might be operated by a public operator or an enterprise, 5G may provide the means to run multiple slices for different communication purposes. In certain embodiments, 5G may enable slices to be independently run and/or isolated from one another.

In some embodiments, a network slice instance (e.g., private or public slice) may include a RAN part and/or a CN part. In various embodiments, a sub-part of a network slice instance may be called a network slice subnet instance (NSSI) which may contain further NSSI.

In certain embodiments, there may be application support for slices, such as in 3GPP 5GS. In some embodiments, an application may use any one of the following managed entities: CS, NSI, NSSI, network functions or other resources in telecom networks such as virtualized network function and/or physical entities such as PNFs.

In various embodiments, there may be slice access with application preference. In certain embodiments, there may be scenarios in which applications (e.g., gaming applications, online video applications, etc.) may access 5GS over multiple slices for different services (e.g., based on user membership) and/or applications may have different priorities on different slices based on an ASP request. In some embodiments, different slices may be available in all provided frequencies or a sub-set of them (e.g., FR1 or FR2 only) based on MNO and ASP agreement and/or network capabilities to support a slice requirement.

In certain embodiments, a mobile network operator has provisioned a set of network slices (e.g., Slice #1, Slice #2, Slice #3) which may be used by different ASPs (e.g., Slice #1 for online video services, Slice #2 for gaming, Slice #3 for eMBB or IOT service).

In some embodiments, different ASPs may use slices (or a subset of them) for different services that they offer. Furthermore, in certain embodiments, if an application changes network slices to be accessed, the application may be agnostic to UEs accessing service and/or may be performed automatically.

In one example, users A and B (e.g., using UE1 and UE2 respectively) have installed game applications and video applications and may have high priorities based on their membership to the video and game services. The high priorities may enable the users A and B to connect automatically to Slice #1 and Slice #2 to guarantee their QoS compared with other users having a lower priority. The priority over the slices to be used by UE1 and UE2 may change based on an ASP request (e.g., a UE moves to a different service area or an area in which a certain frequency is not available, different slice load conditions, or 3rd party ASP rolls out new services and/or applications and the user membership changes).

In various embodiments, a management system of a 5GS operator (e.g., a management domain) may be aware of ASP applications as well as: 1) a kind of slice management related request each application may make; and/or 2) management data that the ASP may consume.

As used herein, non-RT RIC may mean: a logical function that enables non-real-time control and optimization of RAN elements and resources, AI/ML workflow including model training and updates, and policy-based guidance of applications and/or features in Near-RT RIC.

Moreover, as used herein, near-RT RIC and framework functions may mean: a logical function that enables near-real-time control and optimization of RAN elements and resources via fine-grained (e.g., UE basis, cell basis) data collection and actions over an E2 interface. Near-RT RIC may include near-RT RIC basic and/or framework functions which may include subscription management, conflict mitigation, E2 termination (“E2T”), and/or management services.

Furthermore, as used herein, management Services of an RIC platform may include Life-Cycle Management (“LCM”) of an xApp and/or fault, configuration, accounting, performance, security (“FCAPS”) management of Near-RT RIC. These services may be provided by a near-RT RIC to an xApp (e.g., via Open API) or from an SMO (Non-RT RIC) to xApps (via O1).

An xApp as used herein may mean: an application designed to run on a Near-RT RIC. Such an application may be likely to include one or more microservices and at a point of on-boarding may identify which data it consumes and which data it provides. The xApp application is independent of a Near-RT RIC and may be provided by any third party. E2 may enable a direct association between the xApp and RAN functionality.

Moreover, as used herein rApp may mean: an application similar to xApp which is designed to run on a Non-RT RIC. Furthermore, A1 may be an interface between non-RT RIC and Near-RT RIC to enable policy-driven guidance of Near-RT RIC applications and/or functions, and may support AI and/or ML workflow. E2 may refer to an interface connecting a Near-RT RIC and a NR system. Moreover, O1 may refer to an interface between orchestration & management entities and O-RAN managed elements.

In various embodiments, an E2 Node may be a logical node terminating an E2 interface. Moreover, in some embodiments, open API may be an interface between framework functions and xAPPs.

In some embodiments, open API and/or O-RAN API may refer to an interface between framework functions and xAPPs.

In certain embodiments, API management services may enable a RIC platform to provide support for O-RAN APIs (e.g., O-RAN APIs may be defined as open APIs within an O-RAN scope) which may be provided by either a RIC framework or xApps in a service-based manner. In particular, API management services may include: repository and/or registry services for the O-RAN APIs, services that enable discovery of registered O-RAN APIs, services to authenticate xApps for use of O-RAN APIs, and/or services that enable generic subscription and event notification.

In various embodiments, API management services may be accessed via an xApp enablement API by xApps for supporting API discovery, providing authentication, and generic subscription and event notification.

In some embodiments, an application support layer may be used for vertical applications (e.g., known as vertical application enabler layer) which may act as a middleware for exposing northbound APIs to verticals as well as to provide some server-client support functionalities for the connected devices.

In certain embodiments, to be able to use management services and data, management exposure for applications may need to be configured in a corresponding management system. In such embodiments, the management system may be aware of the applications. In various embodiments, a telecom management system may be made aware of applications to enable the applications to register with the telecom management system. In some embodiments, to be able to modify communication services, NSI, or other managed entities, an application may be made aware of a management system.

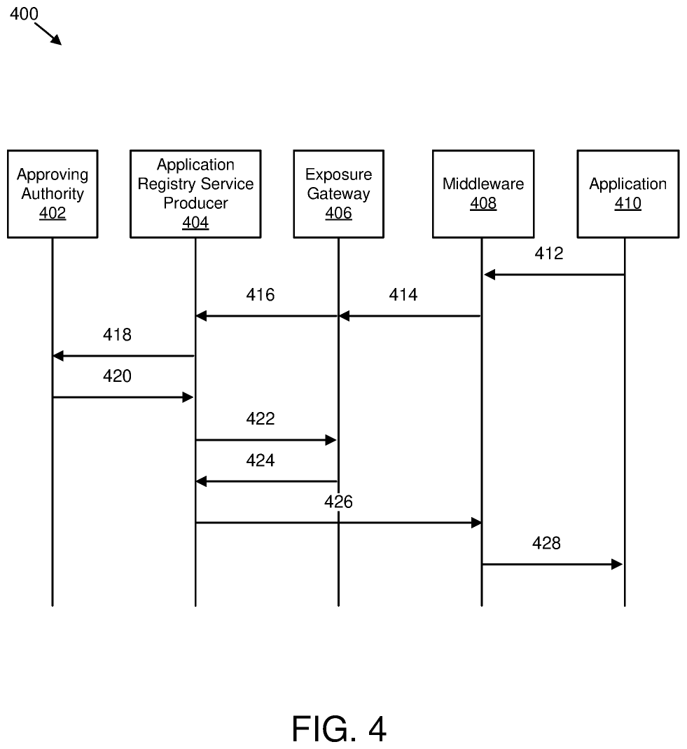

FIG. 4 is a communications diagram illustrating one embodiment of communications 400 for application registration with a telecom management system. The communications 400 include messages transmitted between an approving authority 402 (e.g., for an MD), an application registry service producer 404 (e.g., in an MD), an exposure gateway 406 (e.g., from MD, including exposure governance interface), a middleware 408 (e.g., or trusted application, preauthorized to use the application registry service producer 404), and an application 410 (e.g., or applications). As may be appreciated, each communication of the communications 400 may include one or more messages.

As may be appreciated, in various embodiments: 1) the application 410 may be aware about which management domain to contact for appropriate service handling; 2) there may exist an application or middleware (e.g., the middleware 408) trusted by the management domain that may use the application registry service producer 404; and 3) the approving authority 402 management function may already know a correct exposure for a given application ID middleware 408 combination.

In a first communication 412 transmitted from the application 410 to the middleware 408, the application 410 sends a request to register itself (e.g., registration request) with the middleware 408 optionally providing any one or more of the following: 1) an application identifier; 2) an identifier of a management domain to be registered to; 3) an indication of a level of exposure required and/or management services that need to be exposed; 4) management data to be exposed; 5) IoCs to be exposed; 6) authentication details of the application 410; and/or 7) an associated managed entity in the managed domain (e.g., CS, NSI, NSSI, and so forth) that the application 410 is interested in.

In a second communication 414 transmitted from the middleware 408 to the exposure gateway 406, the middleware 408 transmits the registration request to the exposure gateway 406.

In a third communication 416 transmitted from the exposure gateway 406 to the application registry service producer 404, the exposure gateway 406 transmits the registration request to the application registry service producer 404 (“ARSP”). With the second communication 414 and the third communication 416, the middleware 408 authenticates the application 410 and authorizes that the application 410 is allowed to request registration with the MD. The middleware 408 sends a request to register the application 410 with the respective management domain's application registry service producer 404. As may be appreciated, the registration request may be sent to the application registry service producer 404 via direct communication or the exposure gateway 406. The registration request may include: 1) an application identifier (e.g., a way to identify the application 410); 2) a call back interface to the application 410; 3) an indication of the level of exposure or the management services that need to be exposed; 4) credentials of the application 410; and/or 5) an associated managed entity in the managed domain (e.g., CS, NSI, NSSI, and so forth) that the application 410 is interested in.

In a fourth communication 418 transmitted from the application registry service producer 404 to the approving authority 402, the application registry service producer 404 sends a request for application registration approval to the approving authority 402 (e.g., to determine whether the application 410 can access the requested exposure of management service, function, data, or MOI). The request may include an application ID, an exposure request type, and/or an exposure request ID.

In a fifth communication 420 transmitted from the approving authority 402 to the application registry service producer 404, the approving authority 402 may send an approval to the application registry service producer 404 specifying the approved details (e.g., if the application 410 is approved). The approval may include an application ID, an exposure request type, and/or an exposure request ID.

In a sixth communication 422 transmitted from the application registry service producer 404 to the exposure gateway 406, the application registry service producer 404 configures the exposure gateway 406 for the approved exposure for the application 410. Configuration information for configuring the exposure gateway 406 may include an application ID, an exposure request type, and/or an exposure request ID.

In a seventh communication 424 transmitted from the exposure gateway 406 to the application registry service producer 404, the exposure gateway 406 transmits an acknowledgement of successful configuration to the application registry service producer 404.

In an eighth communication 426 transmitted from the application registry service producer 404 to the middleware 408, the application registry service producer 404 transmits an acknowledgment of successful registration of the application 410 with the management domain to the middleware 408. The eighth communication 426 may include access details for accessing the approved management functions, management services, management data, or MOIs.

In a nineth communication 428 transmitted from the middleware 408 to the application 410, the middleware 408 forwards successful registration information and appropriate access details to the application 410.

It should be noted that an order of the communications 400 may be changed from what is described above. Furthermore, the approving authority 402 and the application registry service producer 404 may be part of the same entity and/or device. In certain embodiments, the approving authority 402 may be a human entity such that the fourth communication 418 may be sent to a dashboard (e.g., computer screen) for the human to approve.

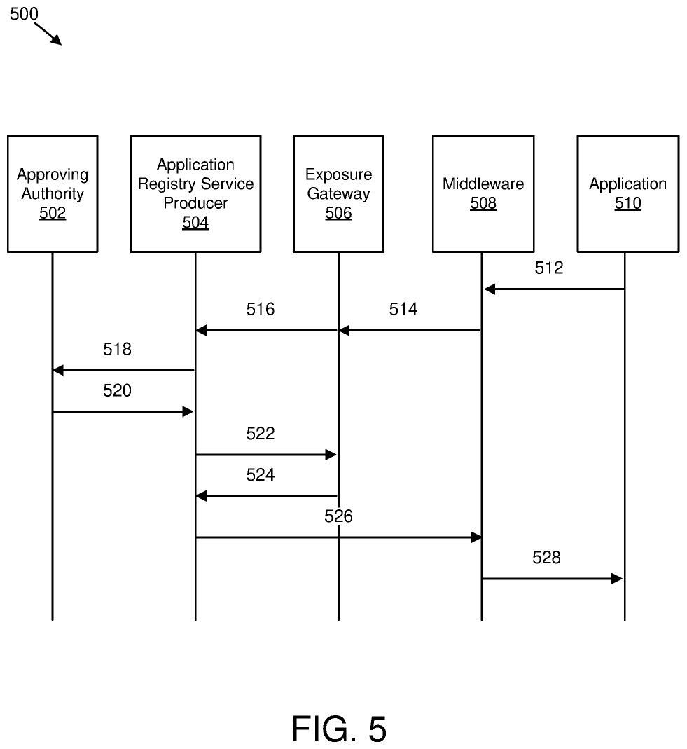

In a first embodiment, the communications 400 of FIG. 4 may be implemented in a 3GPP system. FIG. 5 is a communications diagram illustrating the first embodiment of communications 500 for application registration with a telecom management system (e.g., 3GPP system). The communications 500 include messages transmitted between an approving authority 502 (e.g., for a 3GPP domain), an application registry service producer 504 (e.g., in the 3GPP domain), an exposure gateway 506 (e.g., to the 3GPP domain), a middleware 508 (e.g., or trusted application, preauthorized to use the application registry service producer 504), and an application 510 (e.g., or applications). As may be appreciated, each communication of the communications 500 may include one or more messages.

Specifically, FIG. 5 presents a 3GPP specific embodiment in which applications (e.g., vertical applications) can register to a 3GPP management domain of an operator using the middleware 508 (e.g., SEAL server, any other vertical enabler server, or a CAPIF entity). The first embodiment may assume that: 1) the middleware 508 is trusted by the 3GPP management domain to use the application registry service producer 504; 2) the application 510 knows which 3GPP management domain to connect to (e.g., via PLMN ID, or a REST interface URL); and 3) the approving authority 502 is preconfigured to know what exposures an application and middleware combination is authorized for a request.

In a first communication 512 transmitted from the application 510 to the middleware 508, the application 510 sends a request to register itself (e.g., registration request) with the middleware 508 optionally providing any one or more of the following: 1) an application identifier; 2) an identifier of a 3GPP domain to be registered to (e.g., PLMN ID); 3) an indication of a level of exposure required and/or management services that need to be exposed; 4) management data to be exposed; 5) IoCs to be exposed; 6) authentication details of the application 510; and/or 7) an associated managed entity in the managed domain (e.g., CS, NSI, NSSI, and so forth) that the application 510 is interested in.

In a second communication 514 transmitted from the middleware 508 to the exposure gateway 506, the middleware 508 transmits the registration request to the exposure gateway 506.

In a third communication 516 transmitted from the exposure gateway 506 to the application registry service producer 504, the exposure gateway 506 transmits the registration request to the application registry service producer 504 (“ARSP”). With the second communication 514 and the third communication 516, the middleware 508 authenticates the application 510 and authorizes that the application 510 is allowed to request registration with the 3GPP domain. The middleware 508 sends a request to register the application 510 with the respective management domain's application registry service producer 504. As may be appreciated, the registration request may be sent to the application registry service producer 504 via direct communication or the exposure gateway 506. The registration request may include: 1) an application identifier (e.g., a way to identify the application 510); 2) a call back interface to the application 510; 3) an indication of the level of exposure or the management services that need to be exposed; 4) credentials of the application 510; and/or 5) an associated managed entity in the managed domain (e.g., CS, NSI, NSSI, and so forth) that the application 510 is interested in.

In a fourth communication 518 transmitted from the application registry service producer 504 to the approving authority 502, the application registry service producer 504 sends a request for application registration approval to the approving authority 502 (e.g., to determine whether the application 510 can access the requested exposure of management service, function, data, or MOI). The request may include an application ID, an exposure request type, and/or an exposure request ID.

In a fifth communication 520 transmitted from the approving authority 502 to the application registry service producer 504, the approving authority 502 may send an approval to the application registry service producer 504 specifying the approved details (e.g., if the application 510 is approved). The approval may include an application ID, an exposure request type, and/or an exposure request ID.

In a sixth communication 522 transmitted from the application registry service producer 504 to the exposure gateway 506, the application registry service producer 504 configures the exposure gateway 506 for the approved exposure for the application 510. Configuration information for configuring the exposure gateway 506 may include an application ID, an exposure request type, and/or an exposure request ID.

In a seventh communication 524 transmitted from the exposure gateway 506 to the application registry service producer 504, the exposure gateway 506 transmits an acknowledgement of successful configuration to the application registry service producer 504.

In an eighth communication 526 transmitted from the application registry service producer 504 to the middleware 508, the application registry service producer 504 transmits an acknowledgment of successful registration of the application 510 with the management domain to the middleware 508. The eighth communication 526 may include access details for accessing the approved management functions, management services, management data, or MOIs.

In a nineth communication 528 transmitted from the middleware 508 to the application 510, the middleware 508 forwards successful registration information and appropriate access details to the application 510.

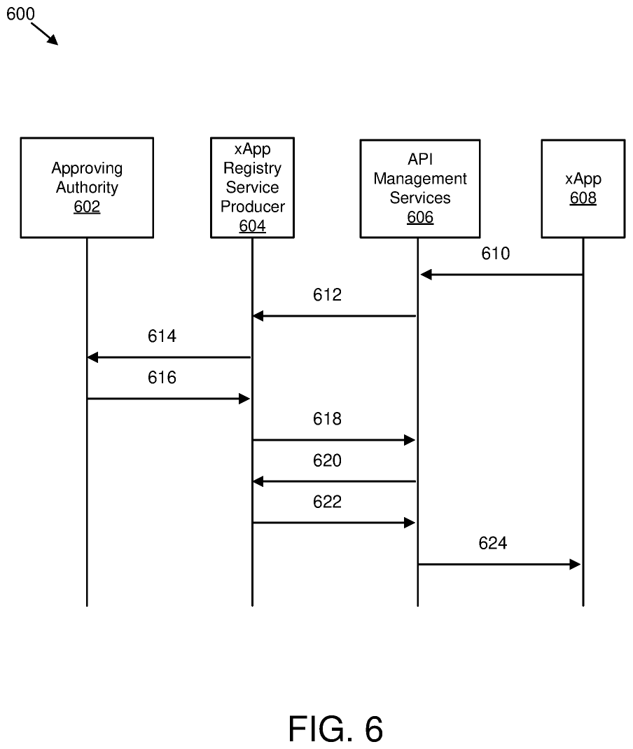

In a second embodiment, the communications 400 of FIG. 4 may be implemented in an O-RAN system. FIG. 6 is a communications diagram illustrating the second embodiment of communications 600 for application registration with a telecom management system (e.g., O-RAN system). The communications 600 include messages transmitted between an approving authority 602 (e.g., for a corresponding MD), an xApp registry service producer 604, a API management services 606 (e.g., middleware, trusted application, preauthorized to use the xApp registry service producer 604), and an xApp 608 (e.g., or xApps). As may be appreciated, each communication of the communications 600 may include one or more messages.

Specifically, FIG. 6 presents an O-RAN specific embodiment in which xApps may register to an RIC platform to use management services (e.g., offered by RIC or any O-RAN entity). The second embodiment may assume that: 1) the API management services 606 is trusted by the O-RAN management domain to use the xApp registry service producer 604; 2) the xApp 608 knows which management domain to connect to (e.g., via a REST interface URL); and 3) the approving authority 602 is preconfigured to know what exposures an application and middleware combination is authorized for a request. Moreover, in FIG. 6, the API management services 606 may be known to the xApp 608 via discovery and/or configuration.

In a first communication 610 transmitted from the xApp 608 to the API management services 606, the xApp 608 sends a request to register itself (e.g., registration request) with the API management services 606 optionally providing any one or more of the following: 1) an xAPP identifier; 2) an identifier of an O-RAN operator and/or management domain to be registered to (e.g., O-RAN network ID); 3) an indication of a level of exposure required and/or management services that need to be exposed; 4) management data to be exposed; 5) IoCs to be exposed; 6) authentication details of the xApp 608; and/or 7) an associated managed entity in the managed domain (e.g., CS, NSI, NSSI, and so forth) that the xApp 608 is interested in.

The API management services 606 authenticates the xApp 608 and authorizes that the xApp 608 can request registration to the xApp registry service producer 604 for the O-RAN MD (e.g., near-RT RIC platform, non-RT RIC platform, an external management system).

In a second communication 612 transmitted from the API management services 606 to the xApp registry service producer 604, the API management services 606 transmits the registration request to the xApp registry service producer 604 (“xARSP”). As may be appreciated, the registration request may be sent to the xApp registry service producer 604 via direct communication or via an operator management service exposure gateway. The registration request may include: 1) an application identifier (e.g., a way to identify the xApp 608); 2) a call back interface to the xApp 608; 3) an indication of the level of exposure or the management services that need to be exposed; 4) credentials of the xApp 608 (e.g., authentication and/or authorization details); and/or 5) an associated managed entity in the managed domain (e.g., CS, NSI, NSSI, and so forth) that the xApp 608 is interested in.

In a third communication 614 transmitted from the xApp registry service producer 604 to the approving authority 602, the xApp registry service producer 604 sends a request for application registration approval to the approving authority 602 (e.g., to determine whether the xApp 608 can access the requested exposure of management service, function, data, or MOI). The request may include an application ID, an exposure request type, and/or an exposure request ID.

In a fourth communication 616 transmitted from the approving authority 602 to the xApp registry service producer 604, the approving authority 602 may send an approval to the xApp registry service producer 604 specifying the approved details (e.g., if the xApp 608 is approved). The approval may include an application ID, an exposure request type, and/or an exposure request ID.

In a fifth communication 618 transmitted from the xApp registry service producer 604 to the API management services 606, the xApp registry service producer 604 configures the API management services 606 for the approved exposure for the xApp 608. Configuration information for configuring the API management services 606 may include an application ID, an exposure request type, and/or an exposure request ID.

In a sixth communication 620 transmitted from the API management services 606 to the xApp registry service producer 604, the API management services 606 transmits an acknowledgement of successful configuration to the xApp registry service producer 604.

In a seventh communication 622 transmitted from the xApp registry service producer 604 to the API management services 606, the xApp registry service producer 604 transmits an acknowledgment of successful registration of the xApp 608 with the management domain to the API management services 606. The eighth communication 626 may include access details for accessing the approved management functions, management services, management data, or MOIs.

In an eighth communication 624 transmitted from the API management services 606 to the xApp 608, the API management services 606 forwards successful registration information and appropriate access details to the xApp 608.

As may be appreciated, FIG. 6 may assume that a gateway to access an xApp registry service is a part of the API management services 606. Furthermore, an xApp registry service may be collocated with the API management services 606.

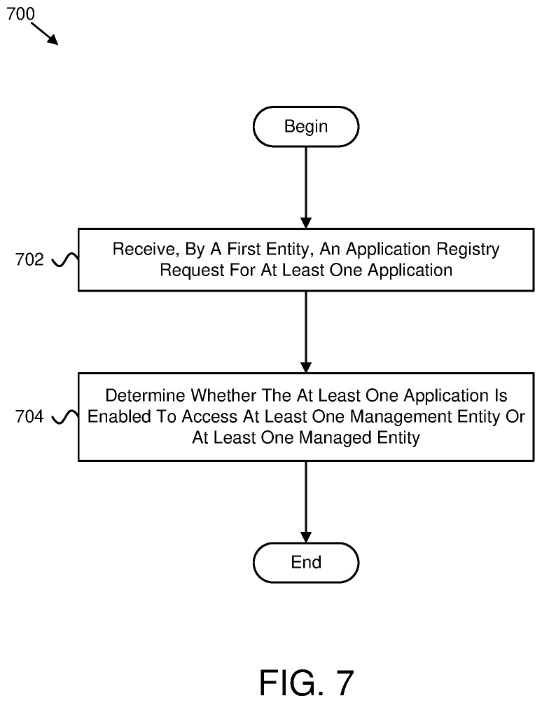

FIG. 7 is a flow chart diagram illustrating one embodiment of a method 700 for entity access for an application. In some embodiments, the method 700 is performed by an apparatus, such as the network unit 104. In certain embodiments, the method 700 may be performed by a processor executing program code, for example, a microcontroller, a microprocessor, a CPU, a GPU, an auxiliary processing unit, a FPGA, or the like.

In various embodiments, the method 700 includes receiving 702, by a first entity, an application registry request for at least one application. In some embodiments, the method 700 includes determining 704 whether the at least one application is enabled to access at least one management entity or at least one managed entity.

In certain embodiments, the method 700 further comprises, in response to determining that the at least one application is enabled to access the at least one management entity or the at least one managed entity, configuring a gateway entity to enable the at least one application to access the at least one management entity or the at least one managed entity. In some embodiments, the application registry request comprises: a network operator; a level of exposure; management services to be exposed; management data to be exposed; information object classes to be exposed; management object instances to be exposed; authentication details associated with an application; an associated managed entity; or some combination thereof.

In various embodiments, the method 700 further comprises: transmitting first information corresponding to the application registry request to an approval device; and receiving second information from the approval device indicating whether the application registry request is approved. In some embodiments, the second information comprises a list of management entities approved, a list of managed entities approved, or a combination thereof. In one embodiment, third information is transmitted to at least one second entity, and the third information indicates whether the application registry request is approved, at least one approved management entity, at least one approved managed entity, information for accessing the at least one approved management entity, information for accessing the at least one approved managed entity, a description corresponding to the at least one approved management entity, a description corresponding to the at least one approved managed entity, or some combination thereof.

In certain embodiments, the at least one second entity comprises any one of a trusted application, a gateway, an application programming interface registry, or the at least one application. In some embodiments, the at least one application is configured to run on a near real-time random-access network intelligent controller. In various embodiments, the first entity comprises a telecom management system, a management domain, a middleware, a trusted application, an application programming interface, a management service implementation, a management function, a management entity, an entity for approving authorizations, or some combination thereof.

In one embodiment, a method comprises: receiving, by a first entity, an application registry request for at least one application; and determining whether the at least one application is enabled to access at least one management entity or at least one managed entity.

In certain embodiments, the method further comprises, in response to determining that the at least one application is enabled to access the at least one management entity or the at least one managed entity, configuring a gateway entity to enable the at least one application to access the at least one management entity or the at least one managed entity.

In some embodiments, the application registry request comprises: a network operator; a level of exposure; management services to be exposed; management data to be exposed; information object classes to be exposed; management object instances to be exposed; authentication details associated with an application; an associated managed entity; or some combination thereof.

In various embodiments, the method further comprises: transmitting first information corresponding to the application registry request to an approval device; and receiving second information from the approval device indicating whether the application registry request is approved.

In some embodiments, the second information comprises a list of management entities approved, a list of managed entities approved, or a combination thereof.

In one embodiment, third information is transmitted to at least one second entity, and the third information indicates whether the application registry request is approved, at least one approved management entity, at least one approved managed entity, information for accessing the at least one approved management entity, information for accessing the at least one approved managed entity, a description corresponding to the at least one approved management entity, a description corresponding to the at least one approved managed entity, or some combination thereof.

In certain embodiments, the at least one second entity comprises any one of a trusted application, a gateway, an application programming interface registry, or the at least one application.

In some embodiments, the at least one application is configured to run on a near real-time random-access network intelligent controller.

In various embodiments, the first entity comprises a telecom management system, a management domain, a middleware, a trusted application, an application programming interface, a management service implementation, a management function, a management entity, an entity for approving authorizations, or some combination thereof.

In one embodiment, an apparatus is in a telecom management system. The apparatus comprises: a receiver that receives an application registry request for at least one application; and a processor that determines at least one management entity or at least one managed entity of the telecom management system based on the application registry request, wherein the at least one application is enabled to access the at least one management entity or the at least one managed entity.

In certain embodiments, the processor configures a gateway entity to enable the application to access the at least one management entity or the at least one managed entity.

In some embodiments, the application registry request comprises: a network operator; a level of exposure; management services to be exposed; management data to be exposed; information object classes to be exposed; management object instances to be exposed; authentication details associated with an application; an associated managed entity; or some combination thereof.

In various embodiments, the apparatus further comprises a transmitter, wherein: the transmitter transmits first information corresponding to the application registry request to an approval device; and the receiver receives second information from the approval device indicating whether the application registry request is approved.

In some embodiments, the second information comprises a list of management entities approved, a list of managed entities approved, or a combination thereof.

In one embodiment, third information is transmitted to at least one second entity, and the third information indicates whether the application registry request is approved, at least one approved management entity, at least one approved managed entity, information for accessing the at least one approved management entity, information for accessing the at least one approved managed entity, a description corresponding to the at least one approved management entity, a description corresponding to the at least one approved managed entity, or some combination thereof.

In certain embodiments, the receiver receiving the application registry request comprises the receiver receiving the application registry request from the at least one application or middleware

In some embodiments, the at least one application is configured to run on a near real-time random-access network intelligent controller.

In various embodiments, the apparatus (or system) comprises at least one computer executable program stored on a plurality of memory devices, and the plurality of memory devices are physically in different locations (e.g., located remote from one another, in different geographic locations).

In one embodiment, the apparatus is a telecom management system, a management domain, a middleware, a trusted application, an application programming interface, a management service implementation, a management function, a management entity, an entity for approving authorizations, or some combination thereof.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method comprising:
receiving, by a first entity, an application registry request for at least one application; and
determining whether the at least one application is enabled to access at least one management entity or at least one managed entity.

2. The method of claim 1, further comprising, in response to determining that the at least one application is enabled to access the at least one management entity or the at least one managed entity, configuring a gateway entity to enable the at least one application to access the at least one management entity or the at least one managed entity.

3. The method of claim 1, wherein the application registry request comprises:
a network operator;
a level of exposure;
management services to be exposed;
management data to be exposed;
information object classes to be exposed;
management object instances to be exposed;
authentication details associated with an application;
an associated managed entity;
or a combination thereof.

4. The method of claim 1, further comprising:
transmitting first information corresponding to the application registry request to an approval device; and
receiving second information from the approval device indicating whether the application registry request is approved.

5. The method of claim 4, wherein the second information comprises a list of management entities approved, a list of managed entities approved, or a combination thereof.

6. The method of claim 4, wherein third information is transmitted to at least one second entity, and the third information indicates whether the application registry request is approved, at least one approved management entity, at least one approved managed entity, information for accessing the at least one approved management entity, information for accessing the at least one approved managed entity, a description corresponding to the at least one approved management entity, a description corresponding to the at least one approved managed entity, or some a combination thereof.

7. The method of claim 6, wherein the at least one second entity comprises any one of a trusted application, a gateway, an application programming interface registry, or the at least one application.

8. The method of claim 7, wherein the at least one application is configured to run on a near real-time random-access network intelligent controller.

9. The method of claim 1, wherein the first entity comprises a telecom management system, a management domain, a middleware, a trusted application, an application programming interface, a management service implementation, a management function, a management entity, an entity for approving authorizations, or some a combination thereof.

10. An apparatus for wireless communications, the apparatus comprising:
a processor; and
a memory coupled to the processor, the memory comprising instructions executable by the processor to cause the apparatus to:
receive an application registry request for at least one application; and
a determine at least one management entity or at least one managed entity of the telecom management system based on the application registry request, wherein the at least one application is enabled to access the at least one management entity or the at least one managed entity.

11. The apparatus of claim 10, wherein the instructions are further executable by the processor to cause the apparatus to configure a gateway entity to enable the application to access the at least one management entity or the at least one managed entity.

12. The apparatus of claim 10, wherein the application registry request comprises:
a network operator;
a level of exposure;
management services to be exposed;
management data to be exposed;
information object classes to be exposed;
management object instances to be exposed;
authentication details associated with an application;
an associated managed entity;
or a combination thereof.

13. The apparatus of claim 10, wherein the instructions are further executable by the processor to cause the apparatus to:
transmit first information corresponding to the application registry request to an approval device; and
receive second information from the approval device indicating whether the application registry request is approved.

14. The apparatus of claim 13, wherein the second information comprises a list of management entities approved, a list of managed entities approved, or a combination thereof.

15. The apparatus of claim 13, wherein third information is transmitted to at least one second entity, and the third information indicates whether the application registry request is approved, at least one approved management entity, at least one approved managed entity, information for accessing the at least one approved management entity, information for accessing the at least one approved managed entity, a description corresponding to the at least one approved management entity, a description corresponding to the at least one approved managed entity, or a combination thereof.

16. The apparatus of claim 10, wherein the instructions are further executable by the processor to cause the apparatus to receive the application registry request from the at least one application or middleware

17. The apparatus of claim 16, wherein the at least one application is configured to run on a near real-time random-access network intelligent controller.

18. The apparatus of claim 10, wherein the apparatus comprises at least one computer executable program stored on a plurality of memory devices, and the plurality of memory devices are physically in different locations.

19. The apparatus of claim 10, wherein the apparatus is a telecom management system, a management domain, a middleware, a trusted application, an application programming interface, a management service implementation, a management function, a management entity, an entity for approving authorizations, or a combination thereof.
